(19) United States
(12) Patent Application Publication
(10) Pub. No.: US 2021/0163081 A1
(43) Pub. Date: Jun. 3, 2021

(54) PICKUP TRUCK REAR CARGO POCKET

(71) Applicant: Wenzhou Tianmao Automobile Parts Co.,Ltd, Wenzhou (CN)

(72) Inventor: Lanhua Cai, Wenzhou (CN)

(73) Assignee: Wenzhou Tianmao Automobile Parts Co.,Ltd

(21) Appl. No.: 17/170,933

(22) Filed: Feb. 9, 2021

(30) Foreign Application Priority Data
Jan. 18, 2021 (CN) 202110065019.4

(51) Int. Cl. B62D 33/02; B60R 9/06

(52) U.S. Cl. CPC B62D 33/0207; B60R 9/06

(57) ABSTRACT

The invention relates to the mechanical field, in particular to a pickup truck rear cargo pocket. A pickup truck rear cargo pocket includes a side plate system, a support rod system and a storage pocket. Through this design, the invention provides a pickup truck rear cargo pocket with simple structure, convenient use and high stability, thus meet users' needs.

### TECHNICAL FIELD

This invention is relevant to mechanical field, especially about pickup truck truck cargo pocket.

### BACKGROUND

pickup truck truck is a kind of car with both car cab and open truck cargo hopper. With its comfortable interior environment, brilliant appearance, strong power, low price and practicality of both passenger and freight, pickup truck's customer covers all walks of life.

However, due to the depth and the width of pickup truck cargo hopper, it is inconvenient to take things out, especially the small items. The large body space increases the difficulty of getting things, especially for short and small car owners.

In view of the problems in the related technology, there is no effective solution yet.

### SUMMARY OF THE INVENTION

The purpose of the invention is to provide a pickup truck rear cargo pocket to solve at least one of the above technical problems.

Thus the invention use the following method:

A pickup truck rear cargo pocket includes a storage pocket body, wherein the storage pocket body includes a support rod system which is used to secure the pickup truck cargo hopper, a side plate system and a storage pocket, the support rod system is mounted on the side plate system, the storage pocket is fixed on the support, rod system;

the side plate system includes two side plates arranged in opposite position, one side of the side plate is provided with a clamp for clamping the pickup truck cargo hopper side rail, the clamp includes a first clamping plate and a second clamping plate, the first clamping plate and the second clamping plate are both provided with bolt holes, the side plate is provided with an installation hole matching the bolt hole, the first clamping plate and the second clamping plate are fixed on the side rail by bolts;

the support rod system includes two support rods arranged in parallel, both sides of the storage pocket are provided with a fixed ring for passing through the support rod;

the supporting rod includes a main rod and two auxiliary rods, the two auxiliary rods are respectively fixed to both sides of the main rod through a rotary joint, both sides of the side plate are provided with a clamping slot for clamping the auxiliary rod, an end cover is arranged on one side of the auxiliary rod near the clamping slot, the end cover is wider than the clamping slot.

The upper part of the second clamping plate is provided with at least three strip-shaped convexities for against the side rail of the pickup truck cargo hopper, the cross section of the strip-shaped convexity is triangular.

There are three mounting holes, the three mounting holes arranged on the side plate from up to bottom.

The rotary joint includes a first connector and a second connector, both the first connector and the second connector are in tubular shape, the first connector includes an auxiliary rod connecting section and a main rod connecting section, the auxiliary rod connecting section is connected with the main rod connecting section, one end of the auxiliary rod is inserted into the connecting section of the auxiliary rod, one end of the main rod is inserted into the connecting section of the main rod;

the main rod connection section is provided with at least three strip-shaped opening slots, the strip-shaped opening slots evenly arranged on the main rod connecting section, the wall thickness of the main rod connecting section which is far away from the auxiliary rod connecting section decreases gradually from front to back;

the outer surface of the main rod connection section is provided with a first external thread, the second connector is arranged outside the main rod connection section, the inner surface of the second connector is provided with a first internal thread which is matching with the first external thread, the inner diameter of the second connector decreases gradually from front to back.

the inner surface of the connecting section of the auxiliary rod is provided with a second internal thread, the auxiliary rod is provided with a second external thread matching with the second internal thread, the joint between the auxiliary rod and the connecting section of the auxiliary rod is coated with screw glue.

The embedded groove includes a horizontal first groove and a sloping second groove, the rear part of the first strip groove is connected with the upper part of the second strip groove.

The side plate is provided with a first slot, a second slot and a third slot for exposing the side rail of the pickup truck cargo hopper, the first slot, the second slot and the third slot are arranged in parallel on the side plate.

Both sides of the side plate are provided with rope piercing holes.

Through this design, the invention provides a pickup truck rear cargo pocket which has simple structure, convenient use and high stability. Through the cooperation of the side plate system, the support rod system and the storage pocket, users can fix the storage pocket in different positions in the pickup truck's cargo hopper, it is convenient to store and take small items, thus meets users' needs.

### BRIEF DESCRIPTION OF THE DRAWINGS

FIG. 1 is a partial structure illustration of this invention

FIG. 2 is a partial structure decomposition illustration of the side plate system in the invention;

FIG. 3 is a partial structure illustration of the clamp in the invention;

FIG. 4 is a partial structure illustration of the support rod system in the invention;

FIG. 5 is a partial structure illustration of the rotary joint in the invention;

FIG. 6 is a schematic diagram of the use state of the invention.

### DETAILED DESCRIPTION OF THE EMBODIMENTS

The following instruction is to further explain the concrete implementation method of the invention.

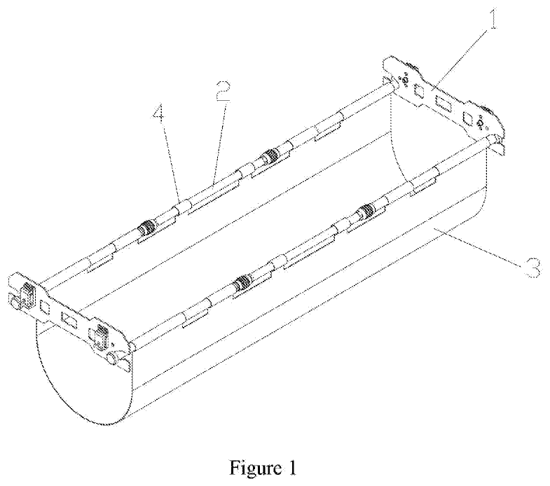

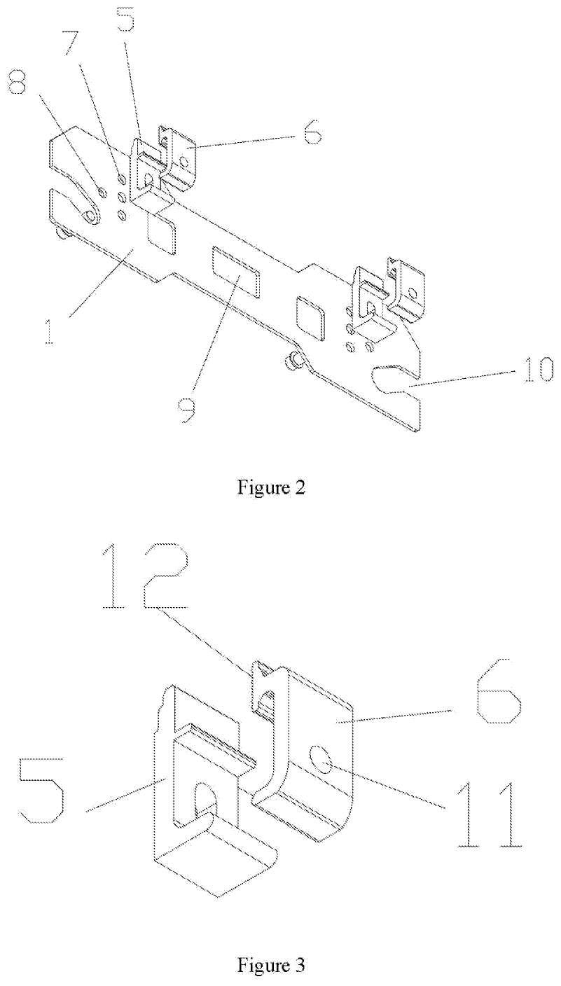

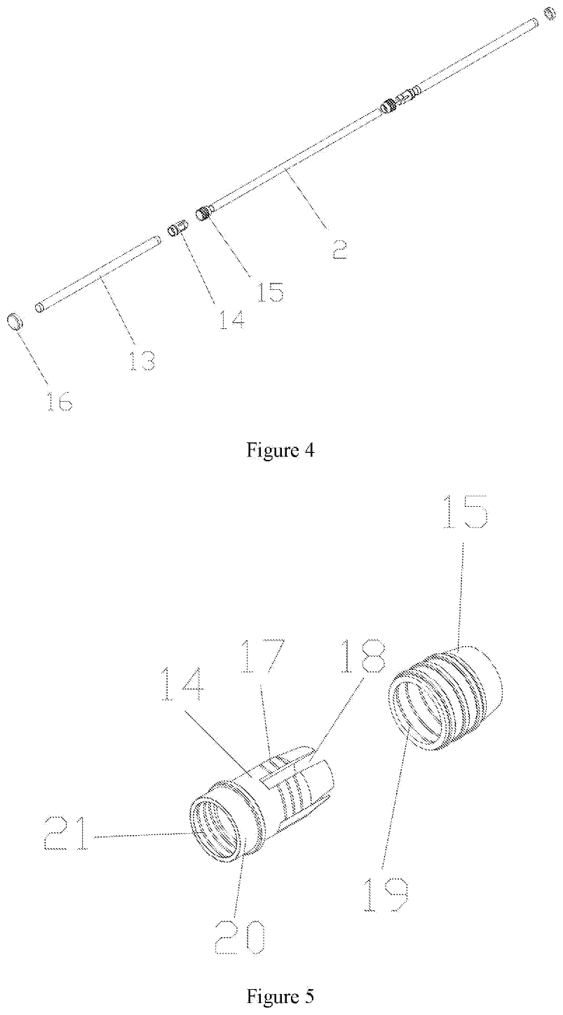

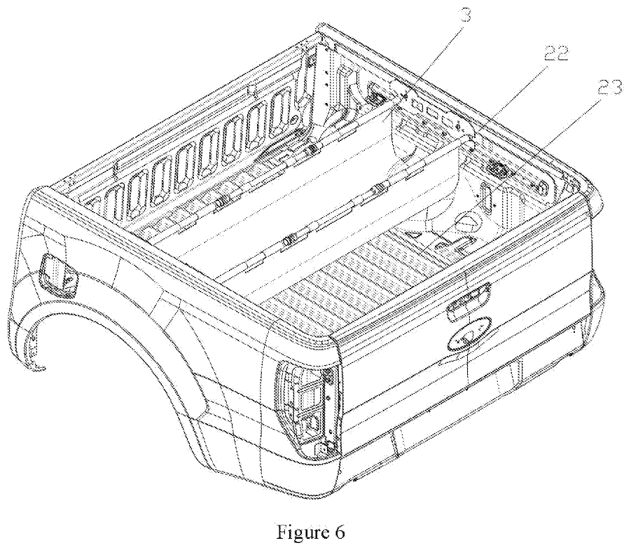

As is seen from FIGS. 1 to 6, a pickup truck rear cargo pocket includes a storage pocket body, the storage pocket body includes a support rod system which is used to secure the pickup truck cargo hopper 23, a side plate system and a storage pocket 3, the support rod system is mounted on the side plate system, the storage pocket is fixed on the support rod system; the side plate system includes two side plates1 arranged in opposite position, one side of the side plate is provided with a clamp for clamping the pickup truck cargo hopper side rail 22 , the clamp includes a first clamping plate 5 and a second clamping plate 6, the first clamping plate and the second clamping plate are both provided with bolt holes 11, the side plate is provided with an installation hole matching the bolt hole 7, the first clamping plate and the second clamping plate are fixed on the side rail by bolts; the support rod system includes two support rods arranged in parallel, both sides of the storage pocket are provided with a fixed ring 4 for passing through the support rod; the supporting rod includes a main rod 2 and two auxiliary rods 13, the two auxiliary rods are respectively fixed to both sides of the main rod through a rotary joint, both sides of the side plate are provided with a clamping slot 10 for clamping the auxiliary rod, an end cover 16 is arranged on one side of the auxiliary rod near the clamping slot, the end cover is wider than the clamping slot. Through this design, the invention provides a pickup truck rear cargo pocket which has simple structure, convenient usage and high stability. Through the cooperation of the side plate system, the support rod system and the storage pocket, users can fix the storage pocket in different positions in the pickup truck cargo hopper, and it is convenient to store and take small items, thus meets users' need.

In order to ensure the effect of the storage pocket, the fixed ring and the storage pocket adopt an integrated structure. The cross section of the storage pocket is semicircular. A number of side bags in parallel can be arranged on the side of the storage pocket. The auxiliary rod and the end cover are connected by threads. Two sides of the storage pocket are respectively provided with six fixed rings which are set on the support rod evenly.

As shown in FIG. 3, the upper part of the second clamping plate is provided with at least three strip-shaped convexities 12 for against the side rail of the pickup truck cargo hopper, the cross section of the strip-shaped convexity is triangular. The upper part of the second clamping plate is provided with a number of strip-shaped convexities to form a serrated surface for contacting the truck side rail, so as to facilitate the clamp to clamp the truck side rail and make it not easily slide or fall off. The upper part of the second clamping plate is in a bending shape, and both the middle part of the first clamping plate and the lower part of the second clamping plate are provided with support sheets for mutual support. When the user tightens the bolt to clamp the truck hopper side rail, the first and second clamping plates are been pulled each other tight, the upper part of the first and second clamping plates are used to clamp the pickup truck cargo hopper side rail, the support plate in the middle of the first clamping plate is against the second clamping plate, the support plate in the lower part of the second clamping plate is against the first clamping plate, so there is a gap between the first clamping plate and the second clamping plate, which is convenient to disassemble, but not easy to rust, so as to improve the service life of the clamp.

There are three mounting holes, the three mounting holes arranged on the side plate from up to bottom to meet the installation requirements of different models of pickup truck cargo hopper side rail.

As shown in FIG. 5, the rotary joint includes a first connector and a second connector 15, both the first connector and the second connector are in tubular shape, the first connector includes an auxiliary rod connecting section 20 and a main rod connecting section 14, the auxiliary rod connecting section is connected with the main rod connecting section, one end of the auxiliary rod is inserted into the connecting section of the auxiliary rod, one end of the main rod is inserted into the connecting section of the main rod; the main rod connection section is provided with at least three strip-shaped opening slots 18, the strip-shaped opening slots evenly arranged on the main rod connecting section, the wall thickness of the main rod connecting section which is far away from the auxiliary rod connecting section decreases gradually from front to back; the outer surface of the main rod connection section is provided with a first external thread 17, the second connector is arranged outside the main rod connection section, the inner surface of the second connector is provided with a first internal thread 19 which is matching with the first external thread, the inner diameter of the second connector decreases gradually from front to back. When installing the support rod, one end of the auxiliary rod is fixed in the connecting section of the auxiliary rod, one end of the main rod is fixed into the connecting section of the main rod, the second connector is rotated to make the external thread on the connecting section of the main rod mesh with the internal thread of the second connector, then the rear part of the connecting section of the main rod is compressed by the second connector, so that the rear part of the connecting section of the main rod is firmly connected with the main rod, the more the external thread on the connecting section of the main rod is engaged with the internal thread on the second connector, the firmer the connection between the connecting section of the main rod and the main rod.

In order to facilitate users to rotate the second connector, the outer surface of the second connector is provided with anti-skid lines.

A limiting ring for confining the second connector is arranged between the main rod connecting section and the auxiliary rod connecting section. The front part of the second connector will be stopped when it rotates to the stop ring to avoid the damage caused by too many turns of the second connector.

A second internal thread 21 is arranged on the inner surface of the connecting section of the auxiliary rod, the auxiliary rod is provided with a second external thread matching with the second internal thread. The joint between the auxiliary rod and the connecting section of the auxiliary rod is coated with screw glue. The auxiliary rod and the connecting section of the auxiliary rod are connected by threads and further fixed by screw glue, so as to ensure the connection strength of the auxiliary rod and the connecting section of the auxiliary rod.

The embedded groove includes a horizontal first strip groove and a sloping second strip groove, the rear part of the first strip groove is connected with the upper part of the second strip groove. One side of the auxiliary rod is embedded with the embedded groove, so that the support rod is fixed between the two side plates. When the auxiliary rod is inserted into the embedded groove, it passes through the first strip groove and the second strip groove in sequence, and fixed at the bottom of the second strip groove finally. This design prevent the auxiliary rod at the embedded groove from shaking up and down when the pickup truck is driving, and ensures the stability of the connection between the support rod and the side plate.

The side plate is provided with a first slot, a second slot 9 and a third slot for exposing the side rail of the pickup truck cargo hopper, the first slot, the second slot and the third slot are arranged in parallel on the side plate. The first slot, the second slot and the third slot can reduce the weight of the side plate and expose the side rail of the pickup truck at the same time, which is convenient to install other equipment, so as to realize the diversified installation of products.

Both sides of the side plate are provided with rope piercing holes 8. Both sides of the storage pocket are provided with fixed ropes, one end of which can be tied to the rope piercing hole to fix the side of the storage pocket.

Finally, it should be noted that: the above is only the preferred embodiment of the invention, and is not used to limit the invention. Although the present invention has been described in detail with reference to the above-mentioned embodiment, for those skilled in the art, it can still modify the technical solutions recorded in the above-mentioned embodiment, or replace some of the technical features of the same. Any modification, equivalent replacement, improvement, etc. made within the spirit and principle of the invention shall be included in the scope of protection of the invention.

1. A pickup truck rear cargo pocket includes a storage pocket body, wherein the storage pocket body includes a support rod system which is used to secure the pickup truck cargo hopper, a side plate system and a storage pocket, the support rod system is mounted on the side plate system, the storage pocket is fixed on the support rod system;
the side plate system includes two side plates arranged in opposite position, one side of the side plate is provided with a clamp for clamping the pickup truck cargo hopper side rail, the clamp includes a first clamping plate and a second clamping plate, the first clamping plate and the second clamping plate are both provided with bolt holes, the side plate is provided with an installation hole matching the bolt hole, the first clamping plate and the second clamping, plate are fixed on the side rail by bolts;
the support rod system includes two support rods arranged in parallel, both sides of the storage pocket are provided with a fixed ring for passing through the support rod;
the supporting rod includes a main rod and two auxiliary rods, the two auxiliary rods are respectively fixed to two sides of the main rod through a rotary joint, both sides of the side plate are provided with a clamping slot for clamping the auxiliary rod, an end cover is arranged on one side of the auxiliary rod near the clamping slot, the end cover is wider than the clamping slot.

2. The pickup truck rear cargo pocket according to claim 1, wherein, the upper part of the second clamping plate is provided with at least three strip-shaped convexities for against the side rail of the pickup truck truck cargo hopper, the cross section of the strip-shaped convexity is triangular.

3. The pickup truck rear cargo pocket according to claim 1, wherein, there are three mounting holes, the three mounting holes arranged on the side plate from up to bottom.

4. The pickup truck rear cargo pocket according to claim 1, wherein, the rotary joint includes a first connector and a second connector, both the first connector and the second connector are in tubular shape, the first connector includes an auxiliary rod connecting section and a main rod connecting section, the auxiliary rod connecting section is connected with the main rod connecting section, one end of the auxiliary rod is inserted into the connecting section of the auxiliary rod, one end of the main rod is inserted into the connecting section of the main rod;
the main rod connection section is provided with at least three strip-shaped opening slots, the three strip-shaped opening slots evenly arranged on the main rod connecting section, the wall thickness of the main rod connecting section which is far away from the auxiliary rod connecting section decreases gradually from front to back;
the outer surface of the main rod connection section is provided with a first external thread, the second connector is arranged outside the main rod connection section, the inner surface of the second connector is provided with a first internal thread which is matching with the first external thread, the inner diameter of the second connector decreases gradually from front to back.

5. The pickup truck rear cargo pocket according to claim 1, wherein, the inner surface of the connecting section of the auxiliary rod is provided with a second internal thread, the auxiliary rod is provided with a second external thread matching with the second internal thread.

6. The pickup truck rear cargo pocket according to claim 1, wherein, the joint between the auxiliary rod and the connecting section of the auxiliary rod is coated with screw glue.

7. The pickup truck rear cargo pocket according to claim 1, wherein, the embedded groove includes a horizontal set first groove and a sloping set second groove, the rear part of the first strip groove is connected with the upper part of the second strip groove.

8. The pickup truck rear cargo pocket according to claim 1, wherein, the side plate is provided with a first slot, a second slot and a third slot for exposing the side rail of the pickup truck cargo hopper, the first slot, the second slot and the third slot are arranged in parallel on the side plate.

9. The pickup truck rear cargo pocket according to claim 1, wherein, the both sides of the side plate are provided with rope piercing holes.
